(19) United States
(12) Patent Application Publication
(10) Pub. No.: US 2024/0138597 A1
(43) Pub. Date: May 2, 2024

(54) PROGRAMMABLE SMART-SENSING SHELF LINER APPARATUS FOR AUTONOMOUS RETAIL

(71) Applicant: THE REGENTS OF THE UNIVERSITY OF CALIFORNIA, Oakland, CA (US)

(72) Inventors: Shijia Pan, Merced, CA (US); Shubham Rohal, Merced, CA (US); Yue Zhang, Merced, CA (US); Carlos Ruiz, Berkeley, CA (US)

(73) Assignee: THE REGENTS OF THE UNIVERSITY OF CALIFORNIA, Oakland, CA (US)

(21) Appl. No.: 18/487,059

(22) Filed: Oct. 14, 2023

Related U.S. Application Data
(60) Provisional application No. 63/381,581, filed on Oct. 31, 2022.

(51) Int. Cl. A47F 5/00; A47F 10/02

(52) U.S. Cl. CPC A47F 5/0018; A47F 5/0081; A47F 10/02

(57) ABSTRACT

A smart retail product shelf liner called ‘MOOCA’ to detect product loads on its surface. The liner preferably has an origami like structure whose properties (e.g., angles, unit size, material) are adjusted to make the liner configurable for different sizes, load ranges, and product packaging. The smart liner is well suited for autonomous checkout systems. MOOCA is an origami-inspired low-cost configurable surface structure having conductive threads and copper wires integrated into the origami structure to detect and recognize product loads and thus to detect when products are either picked-up, or put-down, upon the smart MOOCA liner of the shelf.

### CROSS-REFERENCE TO RELATED APPLICATIONS

This application claims priority to, and the benefit of, U.S. provisional patent application Ser. No. 63/381,581 filed on Oct. 31, 2022, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to retail store shelf liners, and more particularly to a smart shelf liner which senses products placed on, or removed from the liner.

### 2. Background Discussion

Artificial Intelligence (AI) powered autonomous retail stores generally rely on capturing and processing video from multiple overhead cameras to track the interaction of customers with the products. However, any such camera-based application is susceptible to occlusion. The video processing portion of the system must often rely on inferences, and thus is unable to provide reliable determinations of whether products were obtained from the shelves. This becomes a more intractable problem for cameras in a retail store setting; in view of the need to rely on a small number of cameras to provide coverage spanning both customers and products on the shelf. Therefore, the reliance on overhead cameras is both inefficient and error-prone for tracking items on the shelf for customer-product interaction detection and recognition.

Other modalities, such as load sensors, have been explored to acquire this customer-product interaction information when there is occlusion. However, they often require expensive retrofit for the current store setup; for example, in replacing existing shelves with customized shelves equipped with the necessary sensors. So, the load sensor approach generally limits scalability of the system due to the cost in both manufacturing and labor.

Accordingly, a need exists for a low cost smart shelving liner. The present disclosure fulfills that need and provides additional benefits over existing systems.

### BRIEF SUMMARY

This disclosure describes an origami-inspired low-cost configurable surface structure as a smart shelf liner, which is referred to herein as “MOOCA”. The MOOCA system employs conductive threads and wires (e.g., copper wires) integrated into an ‘origami’-type structure to detect and recognize products which are placed on, and/or removed from, the smart shelf liner.

According to an aspect of the technology, a prototype is described which was fabricated with a 3D printed structure using elastic resin. According to another aspect of the technology, MOOCA functionality is demonstrated for detecting the item that is picked up, or that is put back, upon the MOOCA liner. The system can also often detect the type of product, which is being held on the shelf, in response to detecting its size, weight and footprint as it sits on the shelf liner.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a pictorial view of an origami-inspired elastic truss flexible product retention structure according to at least one embodiment of the present disclosure.

FIG. 2 through FIG. 4 are 3D truss meta-structure cells (units), shown in FIG. 2 and FIG. 3, from which a shelf liner of any desired size and shape can be fabricated as shown in FIG. 4, according to at least one embodiment of the present disclosure.

FIG. 5 is a pictorial view of a MOOCA prototype with a 3D printed elastic structure, according to at least one embodiment of the present disclosure.

FIG. 6 is a block diagram of a MOOCA circuit according to at least one embodiment of the present disclosure.

FIG. 7 is a rendering of a working example of a MOOCA liner upon which a container has been placed, as used according to at least one embodiment of the present disclosure.

FIG. 8 is a heatmap image of the working example of FIG. 7, in which voltages are values are seen in the heatmap according to the forces applied at those positions in the heatmap, such as used according to at least one embodiment of the present disclosure.

FIG. 9 is a plot of load response of the different unit cell meta-structures shown in FIG. 2 and FIG. 3, according to at least one embodiment of the present disclosure.

### DETAILED DESCRIPTION

### 1. Introduction

A configurable smart shelf liner apparatus, referred to herein as “MOOCA”, is described. The MOOCA apparatus is capable of event detection, product identification, and inventory monitoring. The MOOCA apparatus is an easy to deploy shelf liner that can turn a conventional (normal, non-sensing) retail store shelf into a smart shelf capable of sensing when a product is placed on, and/or removed from, the shelf. Additionally, the apparatus can identify different products based on registering the bottom shape and size and load, and thus register a force distribution pattern for the product to discern it from other known products.

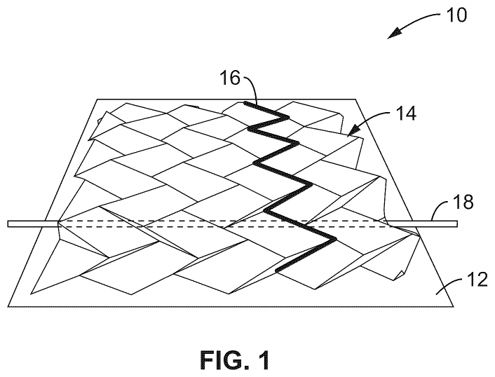

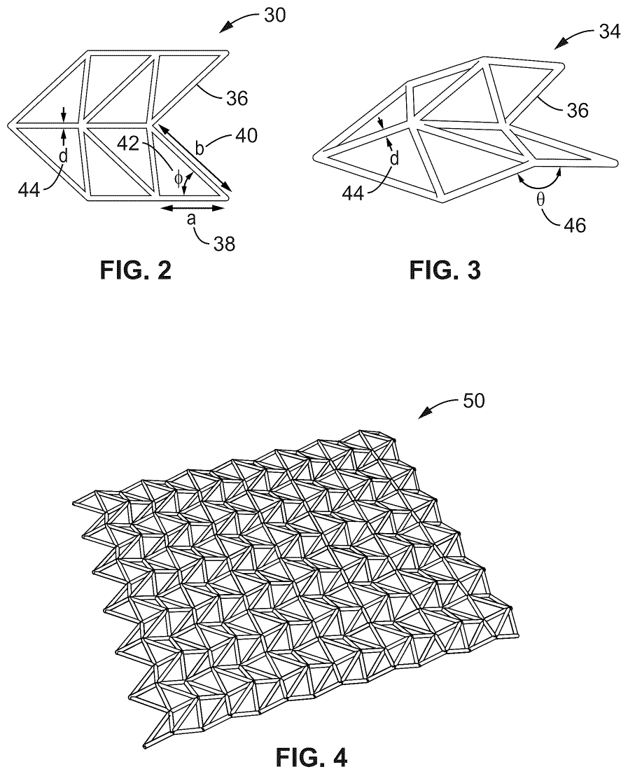

The upper portion of the MOOCA structure which retains the product can be implemented as having a closed or open structure. A closed structure being described below in FIG. 1 comprising planar sections of material between folds in the material. An open structure, as described in regard to FIG. 2 through FIG. 5, is an open lattice of structural elements. In addition, this product retention structure of the MOOCA can also be implemented as a combination open-closed, or closed-open structure, without departing from the teachings of the present disclosure.

In one embodiment, the MOOCA comprises a Muira-Ori origami (a form of origami widely used to fold to pack flat sheets into a smaller space) inspired auxetic structure (consisting of interoperating unit cells). The structure has a negative Poisson's ratio (amount of transversal elongation divided by the amount of axial compression). Due to this property, a MOOCA structure will always undergo reversible deformation and thus require less maintenance.

### 2. MOOCA Design

FIG. 1 illustrates an example embodiment 10 of a MOOCA structure. In this example a base structure was exemplified, which enables configurable design over different target loads. The presented structure has two layers with a first conductive material 16 and a second conductive material 18, which enables load sensing when structure 14 deforms resulting in contact of first and second conductive materials 16 and 18. The structure 14 is a 3D model that is modified from a Miura Ori origami fold. The changes in the 3D fold angles determines the load bearing ability of the structure, hence making it configurable for sensing different ranges of pressures.

A flexible product retention structure 14 is shown attached and/or coupled to a base layer 12, which may be flexible, semi-rigid, or rigid. One of the upper conductive paths 16 is shown ascribing (along) a non-linear path (e.g., zig-zag) on retention structure 14, while one of the lower conductive paths 18 is shown under the flexible product retention structure 14. The non-linearity (e.g., zig-zagging) of the upper conductive paths allow the conductor to flex down toward meeting the lower conductive paths; as a conductor (wire) constrained in a straight line (linear) would not be sufficiently compliant. The overall paths of conductors 16 and 18 are orthogonal to one another, so that each of the multiple upper conductors (one of which is exemplified with conductor 16) passes above each of the lower conductors (one of which is exemplified with conductor 18).

The Miura-Ori origami type structure 14 adopted in this example has the properties of: (1) a quasi-static compression behavior which determines its load bearing ability and leads to deformation when the load exceeds the threshold, and (2) has a negative Poisson's ratio which determines its reversible deformation when the load is removed.

FIG. 2 and FIG. 3 illustrate example embodiments 30, 34 of Three-Dimensional (3D) open frame truss meta-structures which provide different tuning parameters. These structures are shown here as interconnected linear elements 36, exemplified with diameters d 44, stated by way of example and not limitation as these elements need not have a circular cross section, nor are all the elements required to utilize the same-shaped cross section or diameter (width). In the example, these elements are connected to form a series of triangular open areas, although the invention is not limited to using triangular trussed sections. One such of these triangular sections of elements is shown in FIG. 2 with first and second sides a 38 and b 40 between which is subscribed a twist angle ϕ42. In FIG. 3 is shown a structure which also provides a dihedral angle θ 46.

It should be appreciated that tuning parameters such as element diameter d, twist angle ϕ, dihedral angle θ, and lengths a and b in FIG. 2 can alter the load sensitivity of the structure.

FIG. 4 illustrates an example MOOCA structure 50 formed by interconnecting 3D truss structure unit cells, such as seen in FIG. 2 and FIG. 3. In at least one embodiment, the 3D truss structure of unit cells was printed on a 3D printer in a repeating pattern with an elastic resin material. It should be appreciated that by adjusting the tuning parameters, which include element diameter, lengths and connection angles, flexible product retention structures can be created which are suitable for a wide range of products, that may differ for example in size, shape and weight.

In the prototype, the upper conductor was applied as conductive threads woven onto the elastic structure. Alternatively, a wire can be bonded to the structure with heat and/or the use of adhesives. This wire may even comprise a premade wire with knots, or other conductive extensions along its length. In addition, it should be appreciated that the conductor may be embedded onto the flexible structure in various other ways without departing from the teachings of the present disclosure; including use of printing or painting a conductive material to create conductive paths on structure 50.

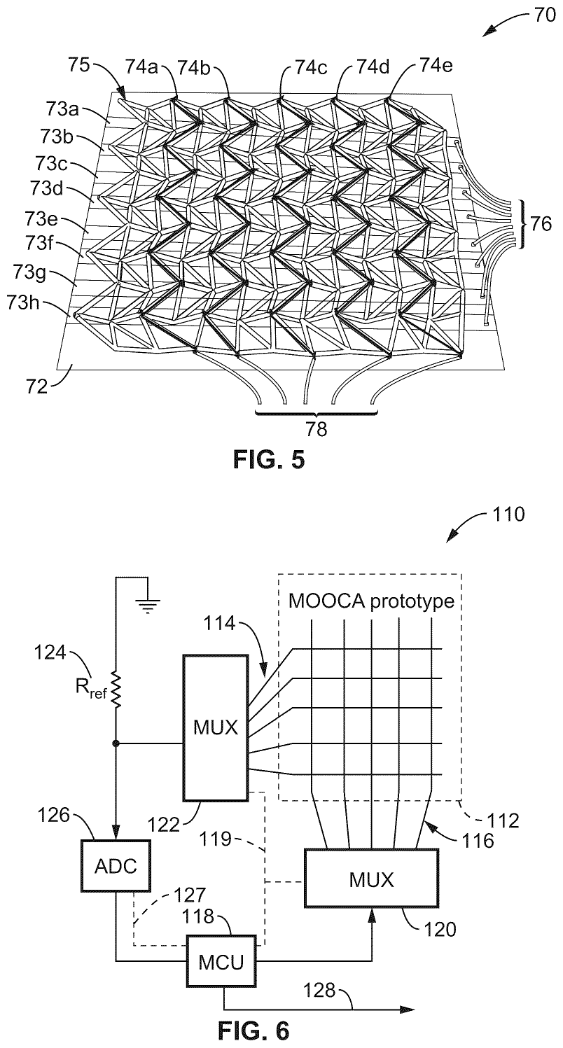

FIG. 5 illustrates an example embodiment 70 showing the structure of FIG. 4, here shown as structure 75, which has been attached over an insulating base section 72 that has conductive paths 73a, 73b, 73c, 73d, 73e, 73f, 73g and 73h. The upper conductors 74a, 74b, 74c, 74d, and 74e, are shown connected along the elements of structure 75 with a direction perpendicular to the copper tapes in the bottom layer, whereby a switch grid is formed having electrical connections 76, 78. It should be appreciated that the smart shelf liners according to the present disclosure may be fabricated to any desired size or shape, and the flexible product retention structure can be fabricated having a configuration of peaks and valleys to accommodate the retention of a wide range of product packaging.

When the load is applied to a meta-structure unit and deforms it, the conductive material (e.g., thread) (74a-74e) on structure 75 will come into contact with one or more of the lower conductive paths (73a-73h), and thus result in a switch connection being made. When the load is removed, the elasticity of the structure provides a restorative force which enables the restoration of the original no-load form, whereby the connection opens up to a non-conductive state. This elasticity of the structure also enables a finer-grained (non-binary) conductivity measurement that is at least somewhat proportional to the weight applied. It will be appreciated that as distortion of the structure under load increases, there is an increasing contact surface between the upper and lower conductors in that area. This is important as it allows product force to be estimated at that particular point on the shelf liner.

The configurable variables in the present example include meta-structure size (rod a and b) length, rod diameter d, twist angle ϕ, and dihedral angle θ. In one embodiment, the MOOCA's dynamic sensing range is configured by changing the parameters of the meta-structure unit shown in FIG. 2 and/or FIG. 3. For example, by tuning the parameters, such as d and θ, the nodal force response of the truss structure can be changed, and hence structural sensitivity to different load ranges can be selected for the application.

For a force F applied on the meta-structure unit, a shear stress component is generated as F*cos(θ/2) along the pole of the structure. When this shear stress exceeds a threshold Thₛₕₑₐᵣ, the deformation occurs. As the angle θ increases, a smaller F is required to satisfy F*cos(θ/2)>Thₛₕₑₐᵣ. This Thₛₕₑₐᵣ is also determined by the pole diameter d, where a reduction in the radius will lead to a lower Thₛₕₑₐᵣ.

In one test, meta structures with two different parameter sets were tested under load. A first meta-structure having a dihedral angle θ of 140° and an element diameter d of 1.5 mm, was subjected to a 71 gram load, and it provided a stable support. A second meta-structure having a dihedral angle θ of 150° and an element diameter d of 1.25 mm, was subjected to the same 71 gram load and had substantial deformation. This demonstrates the use of two structures having different configurations and exhibiting different deformations under the same load.

### 3. Example Embodiment

A working example was fabricated to demonstrate the feasibility of MOOCA. A 3D model based on the meta-structure of FIG. 2 and FIG. 3 having parameters settings of a=10 mm, b=14.14 mm, d=1.25 mm, θ=140° degree, ϕ=45° degree. The model was created with Shapr3D® software to generate the 3D model (FIG. 4) for printing. The Elegoo Saturn S 3D printer was used with Resione® F80 resin to print the model. A conductive thread (Kookye® thread with resistance of 2Ω per foot) was woven onto the 3D printing structure and a knot tied at each movement node on each unit of the meta-structure. The movement node is considered to be one or more places along the unit cell structure, whereby under sufficient displacement force a portion of the conductive material (e.g., the knot) will contact the lower conductor. In the example given, a copper foil tape was used as the conductive material at the lower base layer. The attachment of the wiring (jump wires) to the copper foil tape and to the conductive thread was accomplished using a conductive paint (Bare conductive electric paint).

It should be appreciated that various forms of material for the upper and lower conductors, as well as different forms on connection to those conductors may be utilized without departing from the teachings of the present disclosure.

FIG. 6 illustrates an example circuit embodiment 110 for processing the signals from the MOOCA smart shelf liner structure 112. The figure depicts the MOOCA structure 112 having a first and second set of connections 114, 116 as part of a form of cross-point matrix. Each of these sets of wires is connected to its own multiplexer (mux) 120, 122. In the prototype each multiplexer comprised an analog/digital multiplexer/demultiplexer (e.g., Sparkfun® BOB-09056, containing a CD74HC4067 integrated circuit).

For performing the multiplexing, other circuitry may be utilized; for example, a simpler digital circuit for mux 120, or even driving separate outputs from the MCU itself and eliminating mux 120, insofar as the MCU has a sufficient number of available GPIO pins. In order to characterize the level of contact between grid elements, mux 122 needs to be an analog mux, so that a range of contact levels can be determined based on the current flow through the specific contact nodes. It should be noted that an MCU, or ASIC, may be utilized which contains on board multiplexers, or a sufficient number of ADCs, whereby an external mux and/or ADC circuit would not be necessary. It should be appreciated that although the examples described indicate working with a given number of upper and lower conductors, the present disclosure can be implemented to handle any desired number of cross-point connection locations without departing from the teachings of the present disclosure.

A microcontroller unit (MCU) 118 is shown for controlling measurements from the cross-point matrix of the MOOCA. The MCU is shown connected 119 to control output selection on mux 120, and input selection on mux 122. In addition, the MCU is interfaced 127 to control an Analog-to-Digital converter 126 which takes measurements from the output of mux 122.

It should also be appreciated that the system need not utilize a microcontroller(s), as it may be fabricated with other circuits, such as gate arrays, custom logic and analog circuits, application specific integrated circuit (ASICs), and so forth, and/or combinations thereof without departing from the teachings of the present disclosure.

The following describes a single measurement pass which checks each of the crossing point locations between the upper and lower conductors.

By way of example MCU 118 can set (control) mux 120 to select one line of the lower conductive grid (e.g., 73a of FIG. 5), and mux 122 to select one of the upper grid lines (e.g., 74a of FIG. 5). Then the MCU sends a signal pulse through mux 120, which will be directed along that one line. The MCU monitors for output from mux 122 as registered by Analog-to-Digital (ADC) converter 126. It will be noted that in some cases this ADC would be internal to the MCU, although an external ADC may be used and is shown here for the sake of clarity. The ADC will read a value near ground potential because of pull down resistor 124 (e.g., R=680Ω) on the output of the mux, unless the MOOCA is sufficiently physically displaced at that location by product weight to create some level of electrical contact between lines 73a and 74a. It should be noted that the value of pull down resistance 124 was chosen to provide a tradeoff between higher contact currents, which provide increased sensitivity of measurement, and keeping power consumption beneficially reasonable.

If a given threshold of voltage is reached, then the MCU registers the voltage as a pressure contact and discerns from the measured voltage the relative pressure applied at that point on the smart shelf liner. The correlation between voltage levels and pressure applied is determined for each specific MOOCA design, whereby predetermined threshold values may be programmed onto the MCU. Otherwise, the MCU can perform a calibration procedure with different weights applied to the liner, so to properly discern different product contact pressure levels.

It should be noted that in at least one embodiment/mode/option the MCU after converting voltage measurements to applied force, can identify product types on the shelf based on size and weight and force distribution from the shape of the package bottom pressing against the shelf structure. This is based on predetermined information about product weight and shape, or calibrations performed for the system and loaded into the MCU to capture these product characteristics. Alternatively, or additionally, the characteristics of force distribution may be communicated to the retail store system for it to process, or to further process.

Then the MCU changes mux 122 to select another line of the upper grid (e.g., 74b of FIG. 5), wherein it checks again to determine from the measured voltage from the ADC if there is any level of contact between the upper and lower conductors at that grid node. Then the MCU proceeds to do this same operation for each of the upper lines (e.g., 74c-74e) checking the voltages to determine the level of contact at each of these grid nodes.

The MCU then directs mux 120 to select the next lower conductive line (e.g., 73b of FIG. 5), and iterates through checking each upper grid line (e.g., 74a through to 74e) to determine the level of conductivity. Once this process is completed for each lower conductive line (e.g., 73a-73h of FIG. 5), then a single pass of conduction checking has been concluded wherein each cross-point possibility has been checked. It should be appreciated that the operations described above may be reversed between the upper and lower conductive paths without departing from the teachings of the present disclosure.

The MCU maintains this information about the state at each cross-point, such as by storing and maintaining each measurement in an array of variables. The MCU may also store values for previous measurements, to more readily assess if there are changes. It may also, or alternatively, maintain a rolling average of any desired depth; whereby a current measurement is averaged into a new measurement, as this provides a means for reducing variations between measurements, such as arising from ambient electrical noise.

The information is then conveyed by the MCU through one or more outputs 128 to one or more external systems. In at least one embodiment/mode/option information is not sent to the external system unless there is a change of status (e.g., product placed/removed); however periodic general system status information would be preferably sent so that it can be recognized that the system is operating normally. The form of output communication used depends on the specific application. For example, straightforward digital output can be conveyed from simple SPI, 12C, CAN or similar digital busses, or higher level data collection may be utilized, whether the information is conveyed utilizing a wired bus or a wireless communication.

The higher level data collection would be used for collecting, analyzing, and annunciating/displaying information collected from a number of MOOCA shelves, and may even correlate this data with image processing performed by camera systems. These aspects are application specific and beyond the scope of this discussion.

After completing a pass, the MCU continues performing these tests on a periodic basis, such as completing a pass one or more times per second. Although toward reducing power consumption the sampling rates may be reduced.

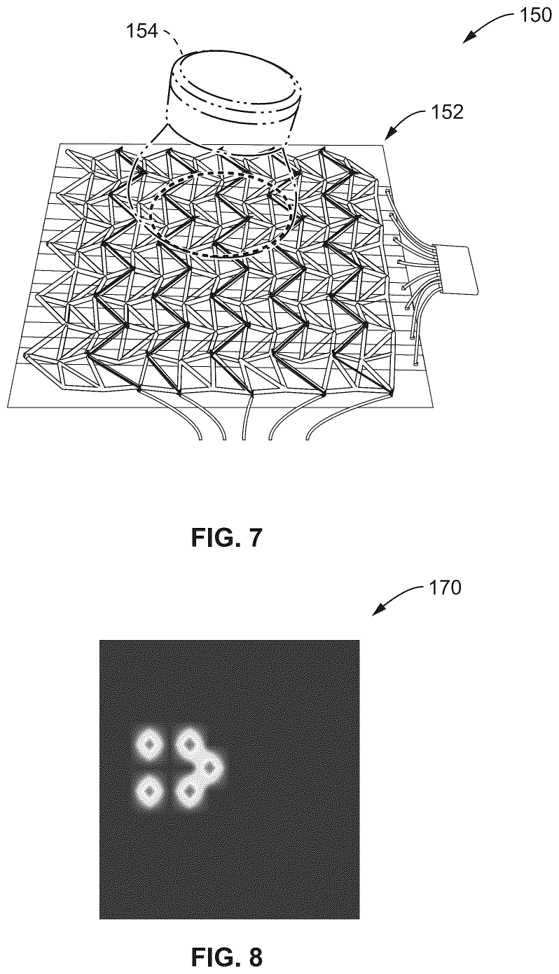

FIG. 7 illustrates an example embodiment 150 of the MCU integrated with MOOCA for product pressure information as output by MOOCA. In the figure, a bottle ‘put-down event’ is shown in which a bottle 154 is placed on the MOOCA smart liner 152.

FIG. 8 illustrates example results 170 of a heatmap of ADC values generated by MOOCA at different cross-point node locations in response to placing product 154 onto the MOOCA. This heatmap is the type of information which can be collected for identifying products, based on size, weight and force distribution.

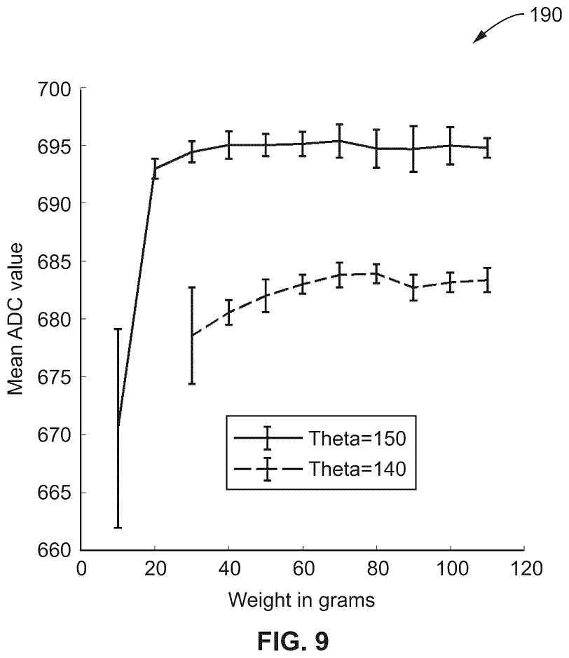

FIG. 9 illustrates an example output 190 comparing outputs from two different configurations of unit cells in response to differing loads. The common variables are a=10 mm, b=14.14 mm, d=1.5 mm, ϕ=45 degree. The solid line (upper plot) shows the average ADC values over the weights between 10 to 110 grams with θ=150 degree, and the dashed line (lower plot) shows these with θ=140 degree. The two curves demonstrate different weight response properties between two different parameter configurations.

### 4. General Scope of Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A store shelf lining apparatus for sensing events of product placement, and product removal, comprising: (a) a base material having a pattern of conductive strips, as a lower conductor grid, oriented in a first direction; (b) a flexible product retention structure coupled to said base material, and extending away from said base material to provide a contoured surface configured for retaining a plurality of products; (c) wherein said flexible product retention structure has a quasi-static compression behavior which determines its load bearing ability and leads to deformation of parts of the structure toward the lower conductive grid when the load applied by any, or all, of the plurality of products exceeds the compression threshold, and said flexible product retention structure has a negative Poisson's ratio which determines its reversible deformation when the load is removed; (d) a pattern of conductive wiring paths coupled along non-linear paths, as an upper conductor grid directed in a second orientation, upon portions of the flexible product retention structure, with conductive wiring on the underside of portions of the flexible product retention structure which are configured to make contact with the pattern of conductive strips under deformation in which the compression threshold is reached; (e) wherein said first orientation of said lower conductive strips is orthogonal to that of said second orientation; (f) a signal source for generating electrical current pulses; (g) a first multiplexer circuit configured for directing a pulse either: (g)(i) along any one of the pattern of conductive strips on the lower conductor grid, or (g)(ii) along any one of the conductive wiring paths of the upper conductor grid; (h) an analog multiplexer circuit having analog inputs connecting to either: (h)(i) any one of the conductive wiring paths of the upper conductor grid, if the first multiplexer circuit is connected along any one of the pattern of conductive strips on the lower conductor grid; or (h)(ii) any one of the pattern of conductive strips on the lower conductor grid, if the first multiplexer is connected along any one of the conductive wiring paths of the upper conductor grid; (j) a resistor coupled to the output of said analog multiplexer circuit, for creating a sufficient current draw to allow determining the extent of electrical conduction when said compression threshold of said flexible product retention structure is reached causing the wiring of said upper conductor grid to make electrical contact with said pattern of conductive strips in the lower conductor grid; (k) an analog-to-digital converter (ADC) configured for measuring the voltage received through the path from the upper conductor grid to the lower conductor grid; (l) a processor coupled to said first multiplexer, said analog multiplexer and to said ADC; (m) a non-transitory memory storing instructions executable by the processor for determining structure compression measurements of said flexible product retention structure; and (n) wherein said instructions, when executed by the processor, perform one or more steps comprising: (n)(i) initializing a measurement pass; (n)(ii) incrementing the selection of a signal path through said first multiplexer; (n)(iii) generating a voltage pulse along said signal path; (n)(iv) iterating through selecting different signal paths from said analog multiplexer and collecting voltage measurements from the ADC; (n)(v) returning back to step (n)(ii) and looping until all signal paths through said first multiplexer have been measured; (n)(vi) converting voltage measurements to applied force for each region in which said upper and lower conductor grids can enter into electrical contact in response to deformation of the flexible product retention structure; (n)(vii) generating signals indicating applied force levels to external systems which are tracking product placement changes on the apparatus; and (n)(viii) repeating the measurements passes in a periodic manner.

A store shelf lining apparatus for sensing events of product placement, and product removal, comprising: (a) a base material having a pattern of conductive strips, as a lower conductor grid, oriented in a first direction; (b) a flexible product retention structure coupled to said base material, and extending away from said base material to provide a contoured surface configured for retaining a plurality of products; (c) wherein said flexible product retention structure has a quasi-static compression behavior which determines its load bearing ability and leads to deformation of parts of the structure toward the lower conductive grid when the load applied by any, or all, of the plurality of products exceeds the compression threshold, and said flexible product retention structure has a negative Poisson's ratio which determines its reversible deformation when the load is removed; (d) a pattern of conductive wiring paths coupled along non-linear paths, as an upper conductor grid directed in a second orientation, upon portions of the flexible product retention structure, with conductive wiring on the underside of portions of the flexible product retention structure which are configured to make contact with the pattern of conductive strips under deformation in which the compression threshold is reached; (e) wherein said first orientation of said lower conductive strips is orthogonal to that of said second orientation; (f) a signal source for generating electrical current pulses; (g) a first multiplexer circuit configured for directing a pulse either: (g)(i) along any one of the pattern of conductive strips on the lower conductor grid, or (g)(ii) along any one of the conductive wiring paths of the upper conductor grid; (h) an analog multiplexer circuit having analog inputs connecting to either: (h)(i) any one of the conductive wiring paths of the upper conductor grid, if the first multiplexer circuit is connected along any one of the pattern of conductive strips on the lower conductor grid; or (h)(ii) any one of the pattern of conductive strips on the lower conductor grid, if the first multiplexer is connected along any one of the conductive wiring paths of the upper conductor grid; (j) a resistor coupled to the output of said analog multiplexer circuit, for creating a sufficient current draw to allow determining the extent of electrical conduction when said compression threshold of said flexible product retention structure is reached causing the wiring of said upper conductor grid to make electrical contact with said pattern of conductive strips in the lower conductor grid; (k) an analog-to-digital converter (ADC) configured for measuring the voltage received through the path from the upper conductor grid to the lower conductor grid; (l) a processor coupled to said first multiplexer, said analog multiplexer and to said ADC; (m) a non-transitory memory storing instructions executable by the processor for determining structure compression measurements of said flexible product retention structure; and (n) wherein said instructions, when executed by the processor, perform one or more steps comprising: (n)(i) initializing a measurement pass; (n)(ii) incrementing the selection of a signal path through said first multiplexer; (n)(iii) generating a voltage pulse along said signal path; (n)(iv) iterating through selecting different signal paths from said analog multiplexer and collecting voltage measurements from the ADC; (n)(v) returning back to step (n)(ii) and looping until all signal paths through said first multiplexer have been measured; (n)(vi) converting voltage measurements to applied force for each region in which said upper and lower conductor grids can enter into electrical contact in response to deformation of the flexible product retention structure; (n)(vii) generating signals indicating applied force levels to external systems which are tracking product placement changes on the apparatus; (n)(viii) repeating the measurement passes in a periodic manner; (o) wherein when said compression threshold of said flexible product retention structure is reached causing the wiring of said upper conductor grid to make an initial electrical contact with said pattern of conductive strips in the lower conductor grid, then as the structure under load increases, there is an increasing contact surface between the upper and lower conductors, which can be detected by measuring voltage at the ADC.

A method for sensing product placement and removal events with a store shelf lining, comprising: (a) configuring a lower section of a flexible shelf liner with conductive strips, as a lower conductor grid, oriented in a first direction; (b) configuring a flexible product retention structure, having structural peaks and valleys, coupled over said lower section of the flexible shelf liner, thereby providing a contoured surface for retaining a plurality of products; (c) configuring the flexible product retention structure to have a quasi-static compression behavior which determines its load bearing ability and leads to deformation of parts of the structure toward the lower conductive grid when the load applied by any, or all, of the plurality of products exceeds the compression threshold, and said flexible product retention structure has a negative Poisson's ratio which determines its reversible deformation when the load is removed; (d) configuring the flexible product retention structure with a pattern of conductive wiring paths coupled along non-linear paths, as an upper conductor grid directed in a second orientation, configured to make contact with the pattern of conductive strips under deformation in which the compression threshold is reached; (e) wherein said first orientation of said lower conductive strips is orthogonal to that of said second orientation; (f) generating an electrical signal source on any one of the conductive strips on the lower or upper conductor grid, and measuring voltage at each opposing grid (upper or lower); (g) converting voltage measurements to applied force for each region in which said upper and lower conductor grids can enter into electrical contact in response to deformation of the flexible product retention structure; (h) repeating generation of the electrical signal source on a subsequent conductive strip, and measuring voltage at each opposing grid, and repeating the process through all combinations of upper and lower conductor grids can make contact; (i) generating signals indicating applied force levels to external systems which are tracking product placement changes on the apparatus; and (j) periodically repeating the signal generation, measurement process and generating signals indicating applied force levels to update the collected information.

The apparatus or method of any preceding implementation, wherein when said compression threshold of said flexible product retention structure is reached causing the wiring of said upper conductor grid to make an initial electrical contact with said pattern of conductive strips in the lower conductor grid, then as the structure under load increases, there is an increasing contact surface between the upper and lower conductors, which can be detected by measuring voltage at the ADC.

The apparatus or method of any preceding implementation, wherein after converting voltage measurements to applied force, a determination is performed which identifies products retained on the flexible product retention structure based on size and weight and force distribution according to the shape of the package bottom.

The apparatus or method of any preceding implementation, wherein said base material and its coupled flexible product retention structure are configured in shapes and sizes suitable for attachment over existing shelving, without the need of replacing the structure of existing shelving.

The apparatus or method of any preceding implementation, wherein said flexible product retention structure comprises a 3D truss meta-structure of interconnected linear elements which form cells, that are interconnected to form a geometric structure configured for compressing to reach the pattern of conductive strips in response to sufficient force being applied by a product placed on said apparatus.

The apparatus or method of any preceding implementation, wherein said interconnected linear elements comprise elastic material.

The apparatus of any preceding implementation, wherein said elastic material comprises elastic resin.

The apparatus or method of any preceding implementation, wherein said flexible product retention structure comprises a 3D truss model that is modified from a Miura Ori origami fold form a geometric structure configured for compressing to reach the pattern of conductive strips in response to sufficient force being applied by a product placed on said apparatus.

The apparatus or method of any preceding implementation, wherein tuning parameters comprising element diameter, lengths and angles are adjusting in creating flexible product retention structures which are suitable for products of different sizes, shapes and weights.

The apparatus or method of any preceding implementation, wherein said apparatus is configured to interface with the electronic equipment controlling Artificial Intelligence (AI) powered autonomous retail stores.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A store shelf lining apparatus for sensing events of product placement, and product removal, comprising:
(a) a base material having a pattern of conductive strips, as a lower conductor grid, oriented in a first direction;
(b) a flexible product retention structure coupled to said base material, and extending away from said base material to provide a contoured surface configured for retaining a plurality of products;
(c) wherein said flexible product retention structure has a quasi-static compression behavior which determines its load bearing ability and leads to deformation of parts of the structure toward the lower conductive grid when the load applied by any, or all, of the plurality of products exceeds the compression threshold, and said flexible product retention structure has a negative Poisson's ratio which determines its reversible deformation when the load is removed;
(d) a pattern of conductive wiring paths coupled along non-linear paths, as an upper conductor grid directed in a second orientation, upon portions of the flexible product retention structure, with conductive wiring on the underside of portions of the flexible product retention structure which are configured to make contact with the pattern of conductive strips under deformation in which the compression threshold is reached;
(e) wherein said first orientation of said lower conductive strips is orthogonal to that of said second orientation;
(f) a signal source for generating electrical current pulses;
(g) a first multiplexer circuit configured for directing a pulse either:
(i) along any one of the pattern of conductive strips on the lower conductor grid, or
(ii) along any one of the conductive wiring paths of the upper conductor grid;
(h) an analog multiplexer circuit having analog inputs connecting to either:
(i) any one of the conductive wiring paths of the upper conductor grid, if the first multiplexer circuit is connected along any one of the pattern of conductive strips on the lower conductor grid; or
(ii) any one of the pattern of conductive strips on the lower conductor grid, if the first multiplexer is connected along any one of the conductive wiring paths of the upper conductor grid;
(j) a resistor coupled to the output of said analog multiplexer circuit, for creating a sufficient current draw to allow determining the extent of electrical conduction when said compression threshold of said flexible product retention structure is reached causing the wiring of said upper conductor grid to make electrical contact with said pattern of conductive strips in the lower conductor grid;
(k) an analog-to-digital converter (ADC) configured for measuring the voltage received through the path from the upper conductor grid to the lower conductor grid;
(l) a processor coupled to said first multiplexer, said analog multiplexer and to said ADC;
(m) a non-transitory memory storing instructions executable by the processor for determining structure compression measurements of said flexible product retention structure; and
(n) wherein said instructions, when executed by the processor, perform one or more steps comprising:
(i) initializing a measurement pass;
(ii) incrementing the selection of a signal path through said first multiplexer;
(iii) generating a voltage pulse along said signal path;
(iv) iterating through selecting different signal paths from said analog multiplexer and collecting voltage measurements from the ADC;
(v) returning back to step (n)(ii) and looping until all signal paths through said first multiplexer have been measured;
(vi) converting voltage measurements to applied force for each region in which said upper and lower conductor grids can enter into electrical contact in response to deformation of the flexible product retention structure;
(vii) generating signals indicating applied force levels to external systems which are tracking product placement changes on the apparatus; and
(viii) repeating the measurements passes in a periodic manner.

2. The apparatus of claim 1, wherein when said compression threshold of said flexible product retention structure is reached causing the wiring of said upper conductor grid to make an initial electrical contact with said pattern of conductive strips in the lower conductor grid, then as the structure under load increases, there is an increasing contact surface between the upper and lower conductors, which can be detected by measuring voltage at the ADC.

3. The apparatus of claim 1, wherein after converting voltage measurements to applied force, a determination is performed which identifies products retained on the flexible product retention structure based on size and weight and force distribution according to the shape of the package bottom.

4. The apparatus of claim 1, wherein said base material and its coupled flexible product retention structure are configured in shapes and sizes suitable for attachment over existing shelving, without the need of replacing the structure of existing shelving.

5. The apparatus of claim 1, wherein said flexible product retention structure comprises a 3D truss meta-structure of interconnected linear elements which form cells, that are interconnected to form a geometric structure configured for compressing to reach the pattern of conductive strips in response to sufficient force being applied by a product placed on said apparatus.

6. The apparatus of claim 5, wherein said interconnected linear elements comprise elastic material.

7. The apparatus of claim 6, wherein said elastic material comprises elastic resin.

8. The apparatus of claim 1, wherein said flexible product retention structure comprises a 3D truss model that is modified from a Miura Ori origami fold form a geometric structure configured for compressing to reach the pattern of conductive strips in response to sufficient force being applied by a product placed on said apparatus.

9. The apparatus of claim 1, wherein tuning parameters comprising element diameter, lengths and angles are adjusting in creating flexible product retention structures which are suitable for products of different sizes, shapes and weights.

10. The apparatus of claim 1, wherein said apparatus is configured to interface with the electronic equipment controlling Artificial Intelligence (AI) powered autonomous retail stores.

11. A store shelf lining apparatus for sensing events of product placement, and product removal, comprising:
(a) a base material having a pattern of conductive strips, as a lower conductor grid, oriented in a first direction;
(b) a flexible product retention structure coupled to said base material, and extending away from said base material to provide a contoured surface configured for retaining a plurality of products;
(c) wherein said flexible product retention structure has a quasi-static compression behavior which determines its load bearing ability and leads to deformation of parts of the structure toward the lower conductive grid when the load applied by any, or all, of the plurality of products exceeds the compression threshold, and said flexible product retention structure has a negative Poisson's ratio which determines its reversible deformation when the load is removed;
(d) a pattern of conductive wiring paths coupled along non-linear paths, as an upper conductor grid directed in a second orientation, upon portions of the flexible product retention structure, with conductive wiring on the underside of portions of the flexible product retention structure which are configured to make contact with the pattern of conductive strips under deformation in which the compression threshold is reached;
(e) wherein said first orientation of said lower conductive strips is orthogonal to that of said second orientation;
(f) a signal source for generating electrical current pulses;
(g) a first multiplexer circuit configured for directing a pulse either:
(i) along any one of the pattern of conductive strips on the lower conductor grid, or
(ii) along any one of the conductive wiring paths of the upper conductor grid;
(h) an analog multiplexer circuit having analog inputs connecting to either:
(i) any one of the conductive wiring paths of the upper conductor grid, if the first multiplexer circuit is connected along any one of the pattern of conductive strips on the lower conductor grid; or
(ii) any one of the pattern of conductive strips on the lower conductor grid, if the first multiplexer is connected along any one of the conductive wiring paths of the upper conductor grid;
(j) a resistor coupled to the output of said analog multiplexer circuit, for creating a sufficient current draw to allow determining the extent of electrical conduction when said compression threshold of said flexible product retention structure is reached causing the wiring of said upper conductor grid to make electrical contact with said pattern of conductive strips in the lower conductor grid;
(k) an analog-to-digital converter (ADC) configured for measuring the voltage received through the path from the upper conductor grid to the lower conductor grid;
(l) a processor coupled to said first multiplexer, said analog multiplexer and to said ADC;
(m) a non-transitory memory storing instructions executable by the processor for determining structure compression measurements of said flexible product retention structure; and
(n) wherein said instructions, when executed by the processor, perform one or more steps comprising:
(i) initializing a measurement pass;
(ii) incrementing the selection of a signal path through said first multiplexer;
(iii) generating a voltage pulse along said signal path;
(iv) iterating through selecting different signal paths from said analog multiplexer and collecting voltage measurements from the ADC;
(v) returning back to step (n)(ii) and looping until all signal paths through said first multiplexer have been measured;
(vi) converting voltage measurements to applied force for each region in which said upper and lower conductor grids can enter into electrical contact in response to deformation of the flexible product retention structure;
(vii) generating signals indicating applied force levels to external systems which are tracking product placement changes on the apparatus;
(viii) repeating the measurement passes in a periodic manner;
(o) wherein when said compression threshold of said flexible product retention structure is reached causing the wiring of said upper conductor grid to make an initial electrical contact with said pattern of conductive strips in the lower conductor grid, then as the structure under load increases, there is an increasing contact surface between the upper and lower conductors, which can be detected by measuring voltage at the ADC.

12. The apparatus of claim 11, wherein after converting voltage measurements to applied force, a determination is performed which identifies products retained on the flexible product retention structure based on size and weight and force distribution according to the shape of the package bottom.

13. The apparatus of claim 11, wherein said base material and its coupled flexible product retention structure are configured in shapes and sizes suitable for attachment over existing shelving, without the need of replacing the structure of existing shelving.

14. The apparatus of claim 11, wherein said flexible product retention structure comprises a 3D truss meta-structure of interconnected linear elements which form cells, that are interconnected to form a geometric structure configured for compressing to reach the pattern of conductive strips in response to sufficient force being applied by a product placed on said apparatus.

15. The apparatus of claim 14, wherein said interconnected linear elements comprise elastic material.

16. The apparatus of claim 15, wherein said elastic material comprises elastic resin.

17. The apparatus of claim 11, wherein said flexible product retention structure comprises a 3D truss model that is modified from a Miura Ori origami fold form a geometric structure configured for compressing to reach the pattern of conductive strips in response to sufficient force being applied by a product placed on said apparatus.

18. The apparatus of claim 11, wherein tuning parameters comprising element diameter, lengths and angles are adjusting in creating flexible product retention structures which are suitable for products of different sizes, shapes and weights.

19. The apparatus of claim 11, wherein said apparatus is configured to interface with the electronic equipment controlling Artificial Intelligence (AI) powered autonomous retail stores.

20. A method for sensing product placement and removal events with a store shelf lining, comprising:
(a) configuring a lower section of a flexible shelf liner with conductive strips, as a lower conductor grid, oriented in a first direction;
(b) configuring a flexible product retention structure, having structural peaks and valleys, coupled over said lower section of the flexible shelf liner, thereby providing a contoured surface for retaining a plurality of products;
(c) configuring the flexible product retention structure to have a quasi-static compression behavior which determines its load bearing ability and leads to deformation of parts of the structure toward the lower conductive grid when the load applied by any, or all, of the plurality of products exceeds the compression threshold, and said flexible product retention structure has a negative Poisson's ratio which determines its reversible deformation when the load is removed;
(d) configuring the flexible product retention structure with a pattern of conductive wiring paths coupled along non-linear paths, as an upper conductor grid directed in a second orientation, configured to make contact with the pattern of conductive strips under deformation in which the compression threshold is reached;
(e) wherein said first orientation of said lower conductive strips is orthogonal to that of said second orientation;
(f) generating an electrical signal source on any one of the conductive strips on the lower or upper conductor grid, and measuring voltage at each opposing grid (upper or lower);
(g) converting voltage measurements to applied force for each region in which said upper and lower conductor grids can enter into electrical contact in response to deformation of the flexible product retention structure;
(h) repeating generation of the electrical signal source on a subsequent conductive strip, and measuring voltage at each opposing grid, and repeating the process through all combinations of upper and lower conductor grids can make contact;
(i) generating signals indicating applied force levels to external systems which are tracking product placement changes on the apparatus; and
(j) periodically repeating the signal generation, measurement process and generating signals indicating applied force levels to update the collected information.
